(19) United States
(12) Patent Application Publication
(10) Pub. No.: US 2024/0215614 A1
(43) Pub. Date: Jul. 4, 2024

(54) BEVERAGES

(71) Applicant: SUNTORY HOLDINGS LIMITED, Osaka-shi, Osaka (JP)

(72) Inventors: Takuya Hashimoto, Tordera (ES); Ana Simo, Tordera (ES); Alba Vinuelas, Tordera (ES); Ana Xaubet, Tordera (ES)

(73) Assignee: SUNTORY HOLDINGS LIMITED, Osaka-shi, Osaka (JP)

(21) Appl. No.: 18/557,605

(22) PCT Filed: May 2, 2022
(86) PCT No.: PCT/JP2022/020002

§ 371 Date: Oct. 27, 2023

(30) Foreign Application Priority Data
May 4, 2021 (GB) 2106328.4

(51) Int. Cl. A23L 2/06; A23L 2/385

(52) U.S. Cl. CPC A23L 2/06; A23L 2/385

(57) ABSTRACT

The present invention provides a beverage comprising an infusion of a citrus fruit. Also provided are methods for the production of a citrus fruit infusion and ingredients, concentrates and beverages comprising said infusion.

This application claims priority from GB2106328.4 filed on 4 May 2021, the contents and elements of which are herein incorporated by reference for all purposes.

### FIELD OF THE INVENTION

The present invention relates to beverages, in particular beverages produced from citrus fruit, more particularly beverages comprising infusions from citrus fruits, and to methods for the production of such beverages.

### BACKGROUND

Citrus fruit is a popular ingredient and flavouring in beverages including, for example, juices and juice-based beverages, carbonated beverages, flavoured waters, and fruit infusions. Consumers are looking more and more for natural, low sugar content and close to ‘home-made’ drinks, for example beverages containing fruit infusions. At the same time consumers do not want to compromise on taste; the average consumer wants a strong taste but also one that is balanced and tastes like the whole fruit, not one that has certain flavour notes which are overpowering compared to others.

The traditional way to make a fruit infusion is to cut up whole fruits and then immerse in water. However, the resultant infusion is rather weak in flavour and aroma and, especially after pasteurization, the taste disappears very quickly. Hence, this is not an ideal method to produce a packaged beverage for sale to the public. Flavour strength can be improved, to an extent, by increasing the amount of fruit added to the infusion. However, economically speaking this is not an ideal solution to provide a beverage having a strong citrus flavour.

Also, while a stronger citrus fruit flavour can be obtained by pressing the flavedo, albedo or pulp of the citrus fruit, as the taste becomes stronger it also becomes more sour and more astringent. This method also leads to sedimentation and cloudiness in the resultant beverage, which is undesirable.

The present invention has been devised in light of the above considerations.

### SUMMARY OF THE INVENTION

The present inventors have discovered that a novel citrus fruit ingredient can be produced from an infusion of ground whole citrus fruit. The novel infusion can be utilised in an improved citrus beverage.

Advantageously, the invention as described herein provides a beverage with a strong citrus flavour, balanced acidity and sweetness, pleasant mouthfeel, low sedimentation and high transparency (low cloudiness). In some embodiments, the beverage may also benefit from improved stability and shelf-life, even in the absence of added stabilisers or preservatives.

Accordingly, in one aspect the present invention provides a beverage comprising an infusion of a citrus fruit, wherein the beverage preferably has a turbidity of 75 NTU or less; a pH of 2.5 to 7; and a soluble solids content of at least 0.1 Brix.

In some embodiments, the beverage has a pH from about 3.0 to about 5.0, preferably about 3.5 to about 4.5.

The beverage is preferably a container packed beverage. In some preferred embodiments, the beverage is pasteurised.

In another aspect the present invention provides a container-packed beverage comprising an infusion of a citrus fruit, wherein the beverage preferably has a turbidity of 75 NTU or less; a pH of 2.5 to 7.

In some embodiments, the container is selected from a can, a glass bottle, a plastic bottle and a barrel.

The beverage may further comprise a juice of a citrus fruit. In preferred embodiments, the beverage does not contain any additional sweetener, or may contain additional sweetener in an amount providing a sweetness in the beverage equivalent to 5.0 degrees Brix of sucrose or less, preferably 3.0 degrees Brix of sucrose or less. A “sweetness equivalent to 1.0 degrees Brix of sucrose” equates to a sweetness of an aqueous solution containing 1 gram of sucrose in 100 grams of the solution.

Another aspect of the present invention provides a concentrate for preparation of a beverage.

Another aspect of the present invention is a method for preparing a beverage, said method comprising the steps of: (i) grinding a whole fruit of a citrus fruit into a size of about 0.5 mm to about 30 mm, to obtain a ground citrus fruit; and (ii) immersing the ground citrus fruit in water, preferably at a temperature of 55° C. or less, to obtain an infusion.

In some embodiments, grinding of the whole citrus fruit is conducted using a mesh or other equipment having a plurality of openings, each opening having a diameter of about 0.5 mm to about 30 mm.

Also provided by the present invention are products, i.e. beverage ingredients, beverage concentrates, or beverage products, which are obtained by or obtainable by the methods described herein.

The invention includes the combination of the aspects and preferred features described, except where such a combination is clearly impermissible or is expressly avoided.

### BRIEF DESCRIPTION OF DRAWINGS

Embodiments and experiments illustrating the principles of the invention will now be discussed with reference to the accompanying figures in which:

FIG. 1 shows some properties of a lemon infusion prepared as described herein, in comparison with alternative lemon ingredients.

FIG. 2 is a spider diagram comparing the volatiles profile of an infusion prepared as described herein with alternative lemon preparations. The lower plot excludes limonene.

FIG. 3 is a bar chart comparing the volatiles present in an infusion prepared as described herein with alternative lemon preparations.

FIG. 4 is a spider diagram comparing the nutritional analysis of an infusion prepared as described herein with alternative lemon preparations.

FIG. 5 shows an exemplary process for the industrial preparation of a beverage as described herein.

FIG. 6 illustrates the chopping of citrus fruits in the methods of the invention and the validation of the size of the chopped pieces.

FIG. 7 shows the different parts of a typical citrus fruit (A. Nakamura, et. al., Solvent Extraction Research and Development, Japan, Vol. 24, No. 1, pp. 37-45 (2017)).

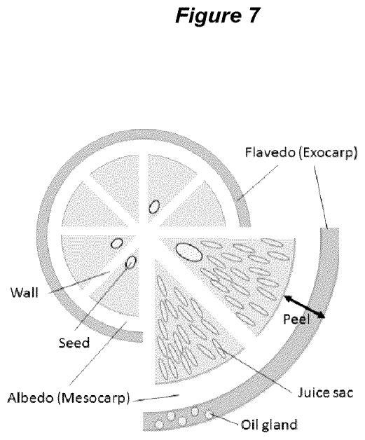

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

The present invention provides a beverage comprising an infusion of a citrus fruit, preferably a whole fruit infusion, most preferably an infusion of a ground whole citrus fruit.

As used herein, the term ‘infusion’ relates to a liquid product obtained when fruit is immersed in water and left to steep (infuse) for a period of time. Methods for the preparation of fruit infusions suitable for use in the beverages of the present invention are described below.

Fresh infusions are prepared by immersing the raw ingredient in cold or boiling water for a short period of time. These are dilute solutions of the readily soluble constituents of the raw ingredient. As will be understood by the person skilled in the art an infusion may also contain small amounts of suspended matter, in addition to the readily soluble constituents, from the raw ingredient. Preferably, suspended matter is no more than 5% of the total, more preferably no more than 3%, most preferably no more than 1% of the total extracted material.

According to the THIE Compendium of Guidelines for Tea Herbal and Fruit Infusions (published 22 Jun. 2018; see Annex 14), a fruit infusion contributes at least 1.2 g/L dry matter and this is typically used as the reference value for a ‘standard strength’ infusion. As will be appreciated by the person skilled in the art, infusions can be prepared in variable strengths. In some embodiments, a standard strength infusion comprises 1.2 g/L dry matter. An ‘intense infusion’, as used herein, may be defined as a fresh infusion containing a much higher amount of material from the raw ingredient (i.e. the fruit), compared to a standard strength infusion. The concentration of soluble constituents obtained from the raw ingredient is much higher, for example at least three times higher, at least five times higher, at least ten times higher, or at least fifteen times higher. In preferred embodiments, the infusions described herein are intense infusions.

In some embodiments, an infusion of the invention is an intense infusion comprising at least 5 g/L dry matter. In some embodiments, the infusion is an intense infusion comprising at least 6 g/L dry matter. In some embodiments, the infusion is an intense infusion comprising at least 8 g/L dry matter. In some embodiments, the infusion is an intense infusion comprising at least 10 g/L dry matter. In some embodiments, the infusion is an intense infusion comprising at least 12 g/L dry matter. In some embodiments, the infusion is an intense infusion comprising at least 14 g/L dry matter. In some embodiments, the infusion is an intense infusion comprising at least 15 g/L dry matter. In some embodiments, the infusion is an intense infusion comprising at least 17 g/L dry matter. In some embodiments, the infusion is an intense infusion comprising at least 20 g/L dry matter.

In some embodiments, the infusion is an intense infusion comprising at most 200 g/L dry matter. In some embodiments, the infusion is an intense infusion comprising at most 175 g/L dry matter. In some embodiments, the infusion is an intense infusion comprising at most 150 g/L dry matter. In some embodiments, the infusion is an intense infusion comprising at most 125 g/L dry matter. In some embodiments, the infusion is an intense infusion comprising at most 100 g/L dry matter. In some embodiments, the infusion is an intense infusion comprising at most 90 g/L dry matter. In some embodiments, the infusion is an intense infusion comprising at most 80 g/L dry matter. In some embodiments, the infusion is an intense infusion comprising at most 70 g/L dry matter. In some embodiments, the infusion is an intense infusion comprising at most 60 g/L dry matter. In some embodiments, the infusion is an intense infusion comprising at most 50 g/L dry matter. In some embodiments, the infusion is an intense infusion comprising at most 40 g/L dry matter. In some embodiments, the infusion is an intense infusion comprising at most 30 g/L dry matter.

The amount of infusion contained in a beverage can be quantified by reference to an equivalent amount of ‘standard strength’ infusion (i.e. by using the THIE reference value). The quoted amount of infusion in the beverage, i.e. the amount stated in an ingredient listing or label, corresponds to this equivalent amount and may be derived from the calculation below:

$$quoted \% amount infusion g / 100 g = \\ \frac{dosage of intense infusion in beverage g / L \times dry matter content of intense infusion g / 100 g}{1.2 g / L reference value}$$

In some embodiments, the beverage of the invention comprises the citrus fruit infusion in an amount equivalent to 15% (i.e. 15 g/100 g) or less of a standard strength infusion. In some embodiments, the beverage comprises the infusion in an amount equivalent to 20% or less of a standard strength infusion. In some embodiments, the beverage comprises the infusion in an amount equivalent to 25% or less of a standard strength infusion. In some embodiments, the beverage comprises the infusion in an amount equivalent to 30% or less of a standard strength infusion.

In some embodiments, the beverage of the invention comprises the citrus fruit infusion in an amount equivalent to at least 1% (i.e. 1 g/100 g) standard strength infusion. In some embodiments, the beverage of the invention comprises the citrus fruit infusion in an amount equivalent to at least 2% (i.e. 2 g/100 g) standard strength infusion. In some embodiments, the beverage of the invention comprises the citrus fruit infusion in an amount equivalent to at least 5% (i.e. 5 g/100 g) standard strength infusion. In some embodiments, the beverage comprises the infusion in an amount equivalent to at least 8% standard strength infusion. In some embodiments, the beverage comprises the infusion in an amount equivalent to at least 10% standard strength infusion. In some embodiments, the beverage comprises the infusion in an amount equivalent to at least 12% standard strength infusion.

In some embodiments, the beverage comprises the infusion in an amount equivalent to 1 to 30% (w/w) of a standard strength infusion, based on the THIE reference value. In some embodiments, the beverage comprises the infusion in an amount equivalent to 5 to 30% (w/w) standard strength infusion. In some embodiments, the beverage comprises the infusion in an amount equivalent to 10 to 30% (w/w) standard strength infusion. In some embodiments, the beverage comprises the infusion in an amount equivalent to 0.1 to 25% (w/w) standard strength infusion. In some embodiments, the beverage comprises the infusion in an amount equivalent to 1 to 25% (w/w) standard strength infusion. In some embodiments, the beverage comprises the infusion in an amount equivalent to 5 to 25% (w/w) standard strength infusion. In some embodiments, the beverage comprises the infusion in an amount equivalent to 10 to 25% (w/w) standard strength infusion. In some embodiments, the beverage comprises the infusion in an amount equivalent to 15 to 25% (w/w) standard strength infusion. In some embodiments, the beverage comprises the infusion in an amount equivalent to 20 to 25% (w/w) standard strength infusion. In some embodiments, the beverage comprises the infusion in an amount equivalent to about 25% (i.e. 25 g/100 g) of a standard strength infusion.

In some embodiments, the beverage of the invention comprises the citrus fruit infusion in an amount contributing at least about 0.1 g/L dry matter to the final beverage. In some embodiments, the beverage comprises the infusion in an amount contributing at least about 0.2 g/L dry matter to the final beverage. In some embodiments, the beverage comprises the infusion in an amount contributing at least about 0.3 g/L dry matter to the final beverage. In some embodiments, the beverage comprises the infusion in an amount contributing at least about 0.4 g/L dry matter to the final beverage.

In some embodiments, the beverage of the invention comprises the citrus fruit infusion in an amount contributing no more than about 0.4 g/L dry matter to the final beverage. In some embodiments, the beverage comprises the infusion in an amount contributing no more than about 0.5 g/L dry matter to the final beverage. In some embodiments, the beverage comprises the infusion in an amount contributing no more than about 0.6 g/L dry matter to the final beverage.

In some embodiments, the beverage of the invention comprises the citrus fruit infusion in an amount contributing 0.1 to 0.6 g/L dry matter to the final beverage. In some embodiments, the beverage of the invention comprises the citrus fruit infusion in an amount contributing 0.2 to 0.5 g/L dry matter to the final beverage. In some embodiments, the beverage of the invention comprises the citrus fruit infusion in an amount contributing 0.2 to 0.4 g/L dry matter to the final beverage. In some embodiments, the beverage of the invention comprises the citrus fruit infusion in an amount contributing about 0.3 g/L dry matter to the final beverage.

Various citrus fruits can be used in the infusions and beverages described herein. In some embodiments, the citrus fruit is selected from lemon, orange, mandarin, grapefruit, lime and other citrus fruits. Other citrus fruits may include, without limitation, kumquat, yuzu, ugli fruit, pomelo, tangerine, tangelo, satsuma, and clementine. In some embodiments, the citrus fruit is selected from lemon, orange, mandarin, grapefruit, and lime. In some embodiments, the citrus fruit is selected from lemon and orange. In some embodiments, the citrus fruit is lemon.

A beverage according to the present invention preferably has a turbidity of 75 NTU or less.

Turbidity is the ‘cloudiness’ of a liquid resulting from the presence of suspended particulate matter. Turbidity in water can be quantified by measuring the propensity of the suspended particles to scatter light. Turbidity can be measured in this way using an instrument called a nephelometer. The units of turbidity from a calibrated nephelometer are called Nephelometric Turbidity Units (NTU).

In some embodiments, for example, turbidity is measured using a HATCH (2100N) turbidimeter. The sample is not diluted for measurement, the beverage is simply placed in the tube in the turbidimeter to obtain directly a NTU value.

In some embodiments the beverage has a turbidity of 60 NTU or less. In some embodiments the beverage has a turbidity of 50 NTU or less. In some embodiments the beverage has a turbidity of 40 NTU or less. In some embodiments the beverage has a turbidity of 30 NTU or less. In some embodiments the beverage has a turbidity of 20 NTU or less. In some embodiments the beverage has a turbidity of 10 NTU or less.

A beverage according to the present invention preferably has a pH in the range of about 2.5 to about 7.0.

The pH value is a standard parameter for measuring acidity. The pH of the beverage can be determined by well-known methods, for example by using a pH meter. The acidity of the beverage may result from natural acids derived from the citrus fruit. In addition, in some embodiments, acidity modifiers including, but not limited to, citric acid, may be added to adjust the pH of the beverage.

In some embodiments, the pH is at least 2.5. In some embodiments, the pH is at least 3.0. In some embodiments, the pH is at least 3.5.

In some embodiments, the pH is no greater than 7.0. In some embodiments, the pH is no greater than 6.5. In some embodiments, the pH is no greater than 6.0. In some embodiments, the pH is no greater than 5.5.

In some embodiments, the pH is from about 3.0 to about 6.0. In some embodiments, the pH is from about 3.0 to about 5.5. In some embodiments, the pH is from about 3.5 to about 6.0. In some embodiments, the pH is from about 3.5 to about 5.5. In some embodiments, the pH is from about 3.5 to about 5.0. In some embodiments, the pH is from about 3.5 to about 4.5.

A beverage according to the present invention preferably has a soluble solids content of at least about 0.1 degrees Brix.

A Brix value, expressed as degrees Brix (°Bx) of soluble solids content, is a measure of the amount of dissolved substances present in a liquid. Soluble solids in the infusions and beverages described herein will comprise mainly sugars but also dissolved organic acids and other compounds, which are derived from the fruit.

Brix can be measured using well known methods, for example using a refractometer or a hydrometer. A refractometer determines degrees Brix by measuring the refraction of light passing through a liquid sample. Liquids containing dissolved solids such as sugars are denser than water and cause greater refraction as light passes through. The instrument compares this to the refraction of light through water and provides the Brix value.

According to CODEX GENERAL STANDARD FOR FRUIT JUICES AND NECTARS the Brix is defined as the soluble solids content of the juice, as determined by the method found in the Section on Methods of Analysis and Sampling. See accepted methods:

| | | |
|---|---|---|
| Soluble solids | AOAC 983.17 | Indirect by refractometry |
| | EN 12143 (1996) | |
| | IFU Method No. 8 (1991) | |
| | ISO 2173: 2003 | |

In some embodiments, for example, Brix is measured by refractometer (Mettler Toledo: RE50), giving a direct value of the soluble solids contained in the sample; analysis is done directly without any sample preparation.

In some embodiments, the beverage has a soluble solids content of at least about 0.1°Bx. In some embodiments, the beverage has a soluble solids content of at least about 0.2°Bx. In some embodiments, the beverage has a soluble solids content of at least about 0.3°Bx. In some embodiments, the beverage has a soluble solids content of at least about 0.4°Bx.

In some embodiments, the beverage has a soluble solids content of at least about 0.5°Bx. In some embodiments, the beverage has a soluble solids content of at least about 0.6°Bx. In some embodiments, the beverage has a soluble solids content of at least about 0.7°Bx. In some embodiments, the beverage has a soluble solids content of at least about 0.8°Bx. In some embodiments, the beverage has a soluble solids content of at least about 0.9°Bx. In some embodiments, the beverage has a soluble solids content of at least about 1.0°Bx. In some embodiments, the beverage has a soluble solids content of at least about 1.2°Bx. In some embodiments, the beverage has a soluble solids content of at least about 1.4°Bx. In some embodiments, the beverage has a soluble solids content of at least about 1.6°Bx. In some embodiments, the beverage has a soluble solids content of at least about 1.8°Bx. In some embodiments, the beverage has a soluble solids content of at least about 2.0°Bx. In some embodiments, the beverage has a soluble solids content of at least about 2.1°Bx.

In some embodiments, the beverage has a soluble solids content of no more than about 0.5°Bx. In some embodiments, the beverage has a soluble solids content of no more than about 1.0°Bx. In some embodiments, the beverage has a soluble solids content of no more than about 2.0°Bx. In some embodiments, the beverage has a soluble solids content of no more than about 3.0°Bx. In some embodiments, the beverage has a soluble solids content of no more than about 4.0°Bx. In some embodiments, the beverage has a soluble solids content of no more than about 5.0°Bx.

The beverage of the invention may comprise at least one oil derived from the citrus fruit. Advantageously, using the methods described herein, citrus oils may be retained in the infusion of the citrus fruit. Without wishing to be bound by theory, the presence of citrus oil in the beverage contributes to a pleasant taste and flavour in the beverage.

The beverage of the invention may comprise volatile components derived from the citrus fruit infusion. Without wishing to be bound by theory, these components may contribute to the flavour and sensory profile of the infusion and hence of the final beverage.

In some embodiments, these components include, but are not limited to: alpha pinene, beta pinene, gamma terpinene, alpha terpineol, bergamotene, beta bisabolene, fenchol, nerol, geraniol, geranyl acetate, and limonene.

In some embodiments, a beverage according to the invention may also comprise further ingredients. For example, in some embodiments the beverage further comprises juice, preferably from a citrus fruit. The juice may be from the same citrus fruit as is used to prepare the infusion described herein. Alternatively, it may be juice from a different fruit.

As used herein, the term ‘juice’ refers to the liquid obtained by mechanically squeezing a fruit.

Fruit juice is the unfermented but fermentable liquid obtained from the edible part of sound, appropriately mature and fresh fruit, or of fruit maintained in sound condition by suitable means including post-harvest surface treatments applied in accordance with the applicable provisions of the Codex Alimentarius Commission (definition found in CODEX STAN 247-2005).

For directly expressed fruit juices, the Brix level shall be the Brix as expressed from the fruit and the soluble solids content of the single strength juice shall not be modified, except by blending with the juice of the same kind of fruit. The table below shows minimum Brix value for some citrus fruit juices (full table can be found in the CODEX STAN 247-2005):

| | | Minimum Brix Level for | Minimum Juice and/or |
|---|---|---|---|
| | Fruit's | Reconstituted Fruit Juices | Purée Content (% v/v) |
| Botanical Name | Common Name | and Reconstituted Purée | for Fruit Nectars |
| Citrus limon (L.) Burm. f. | Lemon | 8.0¹⁷ | According to the |
| Citrus limonum Rissa | | | legislation of the |
| | | | importing country |
| Citrus paradisi Macfad | Grapefruit | 10.0¹⁷ | 50.0 |
| Citrus paradisi, | Sweetie | 10.0 | 50.0 |
| Citrus grandis | grapefruit | | |
| Citrus reticulata Blanca | Mandarine/ | 11.8¹⁷ | 50.0 |
| | Tangerine | | |
| Citrus sinensis (L.) | Orange | 11.8-11.2¹⁷ | 50.0 |
| | | and consistent with the | |
| | | application of national | |
| | | legislation of the importing | |
| | | country but not lower than | |
| | | 11.2. | |
| | | It is recognized that in | |
| | | different countries, the Brix | |
| | | level may naturally differ from | |
| | | this range of values. In cases | |
| | | where the Brix level is | |
| | | consistently lower than this | |
| | | range of values, reconstituted | |
| | | juice of lower Brix from these | |
| | | countries introduced into | |
| | | international trade will be | |
| | | acceptable, provided it meets | |
| | | the authenticity methodology | |
| | | listed in the General Standard | |
| | | for Fruit Juices and Nectars | |
| | | and the level will not be below | |
| | | 10° Brix. | |

Optionally, the juice may be clarified before use. Clarification can be carried out by different processes, for example using UF (ultrafiltration), enzymatic treatment, or using diatomaceous earth and filtration. In some embodiments, the beverage contains the juice in an amount of about 2.0 g/L or less based on the total volume of the beverage.

In some embodiments, the beverage contains the juice in an amount of about 3.0 g/L or less based on the total volume of the beverage. In some embodiments, the beverage contains the juice in an amount of about 4.0 g/L or less based on the total volume of the beverage. In some embodiments, the beverage contains the juice in an amount of about 5.0 g/L or less based on the total volume of the beverage.

In some embodiments, the beverage contains the juice in an amount of about 0.2 g/L or more based on the total volume of the beverage. In some embodiments, the beverage contains the juice in an amount of about 0.5 g/L or more based on the total volume of the beverage. In some embodiments, the beverage contains the juice in an amount of about 1.0 g/L or more based on the total volume of the beverage.

In preferred embodiments, no additional sweetener or sweetening agent is added to the beverage of the invention. In these embodiments the sweetness of the beverage comes entirely from sweeteners derived from the citrus fruit (i.e. natural sugars therefrom). In other embodiments, the beverage of the invention may contain additional sweetener in a small amount e,g, in an amount providing a sweetness equivalent to a sucrose content of no more than 5.0 degrees Brix.

In some embodiments, the beverage of the invention may contain additional sweetener in an amount providing a sweetness equivalent to a sucrose content of no more than 5.0 degrees Brix. In some embodiments, the beverage of the invention may contain additional sweetener in an amount providing a sweetness equivalent to a sucrose content of no more than 4.0 degrees Brix. In some embodiments, the beverage of the invention may contain additional sweetener in an amount providing a sweetness equivalent to a sucrose content of no more than 3.0 degrees Brix. In some embodiments, the beverage of the invention may contain additional sweetener in an amount providing a sweetness equivalent to a sucrose content of no more than 2.0 degrees Brix. In some embodiments, the beverage of the invention may contain additional sweetener in an amount providing a sweetness equivalent to a sucrose content of no more than 1.0 degrees Brix.

Sweeteners which may be added include sugars, such as sucrose, glucose, fructose or dextrose. Other sweeteners such as artificial sweeteners could also be added, as is known in the art.

In some embodiments, other ingredients may optionally be added to the final beverage including, but not limited to, acidulants, flavourings, preservatives, stabilisers, colourings, etc.

Some examples of those ingredients can be: fruity flavours of flavour modifiers, sweeteners like sucralose, stabilisers as for example pectin or gums, preservatives like sorbate and colourings like natural food stuff colours.

A beverage according to the present invention may be a container-packed beverage. In other words, the beverage may be provided in a container, in packaged form.

As used herein, the term ‘container-packed’ is primarily intended to refer to commercially packaged and sealed products, such as would be suitable for commercial supply and/or sale to consumers.

Containers suitable for packaging beverage products are known in the art. In some embodiments the container is, for example, a can (e.g. an aluminium can), a carton, a pouch, a pod, a bag (e.g. in a ‘bag-in-box’ type dispenser), a bottle, a cask, or a barrel. In some embodiments the container is a can, a carton, a pouch, a bottle, or a barrel. In some embodiments the container is selected from a can or a bottle. In some embodiments the container is a can. In some embodiments the container is a bottle. In some embodiments the container is a plastic bottle or a glass bottle.

Also provided herein is a method for preparing a beverage comprising a citrus fruit infusion. The methods of the invention enable production of a citrus fruit beverage with the properties described above.

The method, as described herein, comprises a step of grinding a whole fruit of the citrus fruit, i.e. chopping said whole fruit to a defined size, to produce a ground citrus fruit.

The present inventors have surprisingly found that using the whole fruit (as opposed to e.g. the peel or the pulp) provides the optimal balance between flavour, acidity, mouthfeel, and appearance (transparency) of the infusion and hence of the beverage produced therefrom.

Preferably the whole citrus fruit is chopped (ground) to a size from about 0.5 mm to about 30 mm. In some embodiments, the fruit is chopped to a size from about 1 mm to about 20 mm. In some embodiments, the fruit is chopped to a size from about 2 mm to about 10 mm. In some embodiments, the fruit is chopped to a size from about 2 mm to about 5 mm.

As used herein, the defined ‘size’ of the ground whole citrus fruit effectively refers to the average diameter of the pieces of fruit which are produced in the grinding step. The size of the pieces can be validated after chopping, using methods as described herein e.g. by using a sieve shaker with different mesh sizes to separate and quantify pieces of known diameter.

In some embodiments, the terms ‘grinding’, ‘chopping’ and ‘milling’ may be used interchangeably and refer to the cutting of the fruit into small pieces as described herein. Grinding, chopping, or milling of the citrus fruit may be carried out by various methods, as is known in the art. In some embodiments, for example, grinding is conducted using a mesh, screen or grid, having a plurality of openings. Preferably grinding is carried out using a mesh. The diameter of the openings determines the size to which the fruit is chopped. In some embodiments, therefore, the mesh comprises a plurality of openings each having a diameter of from about 0.5 mm to about 30 mm. In some embodiments, the openings each have a diameter from about 1 mm to about 20 mm. In some embodiments, the openings each have a diameter from about 2 mm to about 10 mm. In some embodiments, the openings each have a diameter from about 2 mm to about 5 mm.

The inventors have found that using ground citrus fruit in a size range as defined herein produces the optimal balance between flavour intensity and undesirable sedimentation (cloudiness). If the fruit pieces used are cut too large, the taste and flavour of the resulting infusion may be too weak. If the fruit pieces are cut too small, increased sedimentation tends to result and the infusion is too cloudy (turbid).

The ground citrus fruit produced as described above is then immersed in water, to obtain an infusion.

The water is preferably at a temperature of 40° ° C. or less. In some embodiments the water is at a temperature of about 10-40° C. In some embodiments the water is at a temperature of about 20-40° C. In some embodiments the water is at a temperature of about 30-40° C. In some embodiments the water is at a temperature of about 40° C.

In some embodiments, the ground whole fruit prepared as described above is added to water, mixed (e.g. using a rotating blade or paddle) then allowed to infuse. In some embodiments, the fruit is allowed to infuse for at least 30 minutes.

In some embodiments, the fruit is allowed to infuse for a period from about 30 minutes to about 45 minutes. In some embodiments, the fruit is allowed to infuse for a period from about 30 minutes to about 60 minutes. In some embodiments, the fruit is allowed to infuse for a period from about 30 minutes to about 90 minutes.

After the infusion step, the fruit pieces may be removed e.g. by centrifugation or filtration.

In some embodiments, one or more stabilisers or processing aids may be added to the resultant infusion, as is known in the art, prior to its further use. Stabilisers are additives used to help maintain emulsions or prevent degeneration in beverages. Among the most common stabilizers are hydrocolloids (such as xanthan, gum arabic and gum acacia), modified starches, pectin, carrageenan, casein and inulin.

The resultant infusion of the whole ground citrus fruit may be utilised as an ingredient in a beverage according to the invention.

In some embodiments, preparation of a beverage according to the invention (for example, a ‘ready-to-drink’ beverage) comprises mixing the infusion with water, optionally blending and/or homogenising.

In some embodiments, preparation of the beverage further comprises the addition of further ingredients as are known in the art including, but not limited to, the further beverage ingredients described above.

The final beverage may be pasteurised using methods known in the art, before being packaged into beverage containers as described above. In some embodiments, the final beverage may be pasteurised using methods known in the art after being packaged into beverage containers as described above.

Alternatively, the resultant infusion of the whole ground citrus fruit may be utilised as an ingredient in a concentrate according to the invention, Beverage concentrates are known in the art and include, but are not limited to, squashes, syrups, cordials, gels and powders.

A concentrate as described herein may be suitable for sale directly to consumers, i.e. for dilution with water in the home. Alternatively, a beverage concentrate may be packaged for dilution at point of sale (e.g. as a wholesale ‘postmix’ product, which is eventually mixed to order in bars, restaurants, etc.). Suitable containers include, but are not limited to, beverage containers as described above.

Accordingly, provided herein is a concentrate for preparing a beverage. The concentrate of the invention comprises, or is derived from, or is prepared from, an infusion of a citrus fruit as described herein. The concentrate of the present invention may be diluted with water in any ratio and used for providing a beverage according to the present invention. For example, the concentrate of the present invention can be used as a syrup or an undiluted solution in a beverage. In this instance, the concentrate can be diluted 2-fold, 3-fold, 4-fold, 5-fold, 6-fold, 7-fold, 8-fold, 9-fold, 10-fold, 15-fold, 20-fold, 25-fold, 30-fold or 35-fold and used. The concentrate of the present invention may be preferable in the aspects of preservability and transportability because it is concentrated. The concentrate of the present invention can be solid or liquid.

In one embodiment, the concentrate of the present invention is a 2 to 35-fold concentrate, preferably a 3 to 30-fold concentrate, more preferably a 5 to 25-fold concentrate, of a beverage of the present invention.

In some embodiments, the concentrate of the invention comprises a whole fruit infusion resulting from an infusion process as described herein (i.e. an intense infusion as described above). Preferably, the concentrate is directly prepared from the whole fruit infusion ingredient described herein.

Accordingly, in some embodiments the infusion ingredient, optionally after the addition of further ingredients as described above but without the addition of further water, or with the addition of only a minimal amount of further water, is pasteurised and packaged into containers, as also described above.

In further embodiments, preparation of a concentrate according to the invention may comprise further concentrating (e.g. evaporating) the whole fruit infusion ingredient (i.e. the ‘intense infusion’ ingredient resulting from the infusion process described herein), before and/or after addition of further beverage ingredients.

In alternative embodiments, a concentrate according to the present invention may be prepared from a beverage of the invention (e.g. a final beverage prepared from the infusion ingredient as described above) by concentrating it (for example, by evaporation) as is known in the art.

In some embodiments, a concentrate according to the invention has a soluble solids content of at least about 5 Brix. In some embodiments, a concentrate according to the invention has a soluble solids content of at least about 10 Brix. In some embodiments, a concentrate according to the invention has a soluble solids content of at least about 15 Brix. In some embodiments, a concentrate according to the invention has a soluble solids content of at least about 20 Brix.

In some embodiments, a concentrate according to the invention has a soluble solids content of no more than about 100 Brix. In some embodiments, a concentrate according to the invention has a soluble solids content of no more than about 90 Brix. In some embodiments, a concentrate according to the invention has a soluble solids content of no more than about 80 Brix. In some embodiments, a concentrate according to the invention has a soluble solids content of no more than about 70 Brix. In some embodiments, a concentrate according to the invention has a soluble solids content of no more than about 60 Brix. In some embodiments, a concentrate according to the invention has a soluble solids content of no more than about 50 Brix. In some embodiments, a concentrate according to the invention has a soluble solids content of no more than about 45 Brix. In some embodiments, a concentrate according to the invention has a soluble solids content of no more than about 40 Brix.

In some embodiments, a concentrate according to the invention has a turbidity of 5000 NTU or less. In some embodiments, a concentrate according to the invention has a turbidity of 4000 NTU or less. In some embodiments, a concentrate according to the invention has a turbidity of 3000 NTU or less. In some embodiments, a concentrate according to the invention has a turbidity of 2500 NTU or less. In some embodiments, a concentrate according to the invention has a turbidity of 2000 NTU or less.

In some embodiments, a concentrate according to the invention has a pH in the range of about 1 to about 6. In some embodiments, a concentrate according to the invention has a pH in the range of about 1.5 to about 5. In some embodiments, a concentrate according to the invention has a pH in the range of about 1.5 to about 4. In some embodiments, a concentrate according to the invention has a pH in the range of about 1.5 to about 3. In some embodiments, a concentrate according to the invention has a pH in the range of about 1.5 to about 2.5.

In some embodiments, the concentrate of the invention comprises a citrus fruit infusion as described herein in an amount contributing 1 to 25 g/L dry matter to the total beverage concentrate. In some embodiments, the beverage of the invention comprises the citrus fruit infusion in an amount contributing 2 to 20 g/L dry matter. In some embodiments, the beverage of the invention comprises the citrus fruit infusion in an amount contributing 5 to 20 g/L dry matter. In some embodiments, the beverage of the invention comprises the citrus fruit infusion in an amount contributing 5 to 10 g/L dry matter. In some embodiments, the beverage of the invention comprises the citrus fruit infusion in an amount contributing about 7 g/L dry matter.

The present invention also provides products, i.e. beverage ingredients or beverage products, which are obtained by or obtainable by the methods described herein.

In some embodiments, the invention provides an ingredient (e.g. citrus fruit infusion) which is obtainable by or obtained by a method as described herein. In some embodiments, the invention provides a beverage which is obtainable by or obtained by a method as described herein. In some embodiments, the invention provides a concentrate (i.e. a beverage concentrate) which is obtainable by or obtained by a method as described herein. In some embodiments, the invention provides a citrus fruit infusion which is obtained by or obtainable by a method as disclosed herein. In some embodiments, an infusion is obtained by or obtainable by a method including the steps of (i) grinding a whole citrus fruit into a size of 0.5 mm to 30 mm to obtain a ground citrus fruit; and (ii) immersing the ground citrus fruit in water at a temperature of 40° ° C. or less, to obtain said infusion.

In some embodiments, the invention provides a beverage which is obtainable by or obtained by mixing said infusion with water and, optionally, other beverage ingredients. In some embodiments, the beverage is a beverage as described above.

In some embodiments, the invention provides a concentrate which is obtainable or obtained from said infusion, by optionally mixing it with other ingredients and/or concentrating it. In some embodiments, the concentrate is a concentrate as described above.

Also provided by the present invention is the use of an infusion as described herein, for example an infusion which is obtained by or obtainable by a method as disclosed herein, in the preparation of a beverage. Also provided by the present invention is the use of an infusion as described herein, for example an infusion which is obtained by or obtainable by a method as disclosed herein, in the preparation of a concentrate.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example+/−10%.

### EXAMPLES

### Example 1—Production of Lemon Infusion

Lemon pieces are obtained by fractionating the lemon fruit (whole fruit) into sizes from 0.5 to 3 mm. This is poured into water at ratio shown in table (1), then blended and keep for 30 minutes minimum at 40° C. or less. After that, fruit pieces are separated by using centrifugal separation equipment, obtaining a lemon infusion in an amount as shown in Table (1).

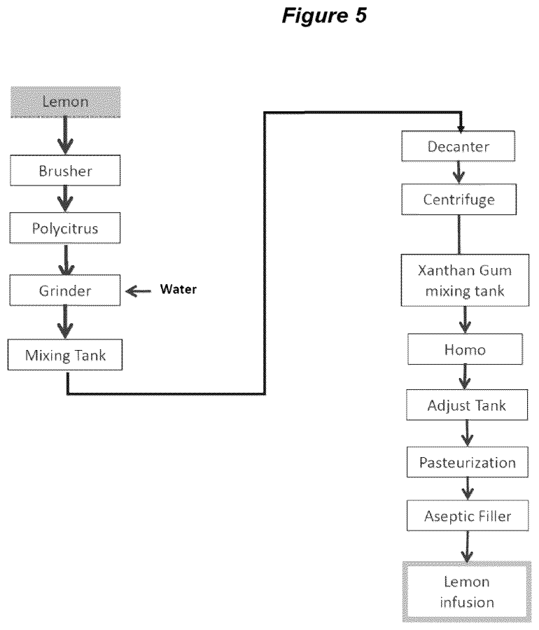

The resultant infusion can then be used to make beverages: just pour it with water and any other ingredients and blend until properly homogenized. An exemplary process is illustrated in FIG. 5.

TABLE 1
production of lemon infusion

| | |
|---|---|
| Fresh fruit | 33 wt % |
| Water | 67 wt % |
| Final Infusion (intense) | 60 kg |

### Example 2 Finished Product Preparation

A lemon intense infusion, clarified juice, natural flavours and water are mixed so as to have the compounding amount shown in Table (2) and then filled in a PET bottle container to prepare a sample solution.

TABLE 2
production of citrus beverage (w/w %)

| | |
|---|---|
| Water | 95.5 |
| Infusion | 1.5* |
| Juice | 2 |
| Flavour | 1 |

*1.5% intense infusion, corresponding to 25% standard strength infusion, according to THIE calculation.

### Example 3 PH Levels Experimental Data

Evaluation method: pH of the beverage was modified either using Citric Acid solution at 50% or Sodium Citrate solution at 20% in order to get the same beverage at different pH levels. Citric Acid solution or Sodium Citrate solution was added to the beverage sample in continuous agitation, measuring pH with a pH-meter. Finally, samples were tasted and compared as shown in Table (3) below:

TABLE 3
pH levels comparison

| | | | | TARGET | | |
|---|---|---|---|---|---|---|
| | pH level | | | | | |
| | 2.3 | 2.5 | 3 | 4 | 5 | 5.5 |
| ATTRIBUTES | −− | − | + | +++ | + | − |
| TO EVALUATE: | | | | | | |
| balanced | | | | | | |
| acidity and | | | | | | |
| fresh fruit | | | | | | |
| perception | | | | | | |
| TASTING | ripe lemon | Very acid | Acidic lemon | Natural and | Less lemon | Very low or |
| comments | juice taste, | taste, like a | taste, more | fresh lemon | taste | almost not |
| | even a bit | drink with | like a drink | taste, like | intensity, | lemon taste |
| | disgusting | only lemon | made with | water with | lower | neither |
| | as very | juice | water + | fresh lemon | freshness, | refreshing |
| | high acidity | | lemon juice. | pieces; | more like | feeling. Taste |
| | level | | Very low full | Balance of | natural | more similar |
| | | | fruit profile | soft acidity | carbonated | to normal |
| | | | and almost | and full fruit | mineralized | mineralized |
| | | | non peely | profile. | waters with a | water. |
| | | | notes | | bit of lemon | |
| | | | | | taste. | |

Evaluation: Evaluation criteria
+++ Main profile target
++ Main profile is similar from target but different intensity in some attributes
+ Main profile has some similarities with target but in different overall intensity
− Main profile is different from target but has some attributes also present in the target
−− Main profile is different from target
−−− Main profile is very far from target

### Example 4—Extraction Temperatures Experimental Data

The infusion was prepared using fresh lemons from market, fractionating it in pieces from 0.5 to 3 mmm and immersing into water during 30 minutes at different temperatures (10, 20, 40 and 60° C.). Brix evaluation and sensory test were applied to compare the samples as shown in Table (4) below:

TABLE 4
temperature comparison

| | Test 1 | Test 2 | Test 3 | Test 4 |
|---|---|---|---|---|
| T (° C.) | 10 | 20 | 40 | 60 |
| °Brix | 1.69 | 1.79 | 2.14 | 2.29 |
| Tasting attributes target: | Refreshing; strong | Refreshing with | Refreshing, with | Less refreshing, |
| balanced complexity with full | acidity and less | acid-bitter balance. | more bitter notes | mainly bitter and |
| lemon profile, soft acidity and | intensity in full | Full lemon profile | and correct acidity. | acid taste as |
| bitterness and refreshing | lemon profile in | in terms of aroma | Full lemon profile | predominant |
| sensation | terms of aroma and | and taste | but less peely | attributes, not full |
| | taste | | notes and aroma | lemon profile in |
| | | | intensity | aroma neither |
| | | | | taste |
| Acceptance criteria | + | +++ | ++ | − |

Evaluation: Evaluation criteria
+++ Main profile target
++ Main profile is similar from target but different intensity in some attributes
+ Main profile has some similarities with target but in different overall intensity
− Main profile is different from target but has some attributes also present in the target
−− Main profile is different from target
−−− Main profile is very far from target

### Example 5—Specification Range Experimental Data

### Cutting Size

To evaluate how the shape and cutting size affects to the taste, we choose three lemons which are almost the same size and made an infusion by different cutting ways. As we cut smaller, intensity becomes strong. But if we cut too small, solid separation is difficult. Therefore we recommend between 0.5 mm to about 30 mm size. Best size is less than 10 mm.

### Parts Selection

To confirm the taste and flavour, we tried to make infusion with different parts of lemon and compared the taste. We make 3 samples only pulp part, only peel part and whole lemon and milled around 1 cm and compare the taste.

Consumers of soft drinks were asked to describe the best tasting lemon drink. The descriptive comments (such as quite acidic, but not too much, plus a little bit sweet) were translated by expert sensory scientists and trained sensory panellists into a profile of an ideal lemon beverage. A list of attributes were agreed for a lemon drink and the scale was set at 0-5, scores reflecting the consumers' description were selected on the scale for each attribute in order to define the “Target” product. Then, each part was prepared and tasted by the sensory panel.

For tasting, a panel of 5 trained* people was selected and tasted the samples in order to quantify and qualify the different attributes defined, to understand organoleptic profile of the tested infusions. The objective of the tasting was to identify the intensity of the different attributes agreed and place it in the scale from 0 to 5 (0 being not present and 5 being the highest level). *Tasters are periodically trained in tasting citrus fruits, by doing an internal exercise aimed to identify and define a common organoleptic language to describe citrus fruits. This exercise consists of tasting different samples in a blind test (those samples are prepared using a certain dosage of lonely citrus fruits attributes such as fruity, fresh, green, peely, etc) and identifying correctly the organoleptic attribute corresponding to each sample.

TABLE 5

| | | Parts of the fruit | | | | | |
|---|---|---|---|---|---|---|---|
| | | Pulp | Whole | Pulp | Whole | Peel | Whole |
| | | Particle size | | | | | |
| | Target | Segments | Segments | Milled | Sliced | Milled | Milled |
| Sweetness | 1.5 | 1.5 | 1.5 | 1.5 | 1.5 | 1.5 | 1.5 |
| Acidity | 3 | 4 | 3.5 | 4 | 3.5 | 3.5 | 3 |
| Bitterness | 2 | 1 | 2 | 1.5 | 2 | 2.5 | 2 |
| Cooked | 0 | 0 | 0 | 0 | 0 | 0 | 0 |
| Refreshing | 4.5 | 2 | 3 | 2 | 3.5 | 4.5 | 4 |
| Peely & oily | 3.5 | 1 | 2.5 | 1.5 | 3 | 4 | 3 |
| notes | | | | | | | |
| General | 4 | 1.5 | 2 | 3 | 2.5 | 4 | 3 |
| intensity | | | | | | | |
| Acceptance | +++ | | | + | | ++ | +++ |
| criteria | | | | | | | |

Milling is preferred to slicing in terms of overall sensory attributes. Overall acceptance criteria were ranked for milled samples. Pulp part is no flesh notes less refreshing. Peel part is too strong and strong bitterness. Whole fruit is balanced.

Once the scoring was complete it was reviewed and the Whole Milled part had the profile that was closest to the target, so therefore this part (Whole Fruits) was selected for further experimentation.

### Example 6—Minimum Brix Experimental Data

An experimental method was designed to prepare a lemon infusion as it might be prepared at home. Slices of lemon were poured into water at ambient temperature in an amount of 10% (w/w) (this amount was based on a tea infusion preparation at home where people add 1 tea bag (2 g of tea leaf) to a cup of water (200 ml total volume)). We analyzed Brix of the infusion every 10 minutes until 1 h of time (we decided 1 h it is time enough to consider infusion finalized).

Value of this lemon fresh fruit infusion representing what can be prepared at home is shown in Table (8).

TABLE 6

| LEMON SLICES | weight (g) | Time (min) | Brix |
|---|---|---|---|
| LEMON (g) | 102.74 | 0 | 0.03 |
| TOTAL weight (g) | 1003.6 | 10 | 0.06 |
| WATER (g) | 894.86 | 20 | 0.07 |
| T^{a} ° C. | 20.4 | 30 | 0.08 |
| Final weight (g) | 848.22 | 40 | 0.11 |
| | | 50 | 0.13 |
| | | 60 | 0.12 |

### Example 7—Lemon Crush Size Validation Method

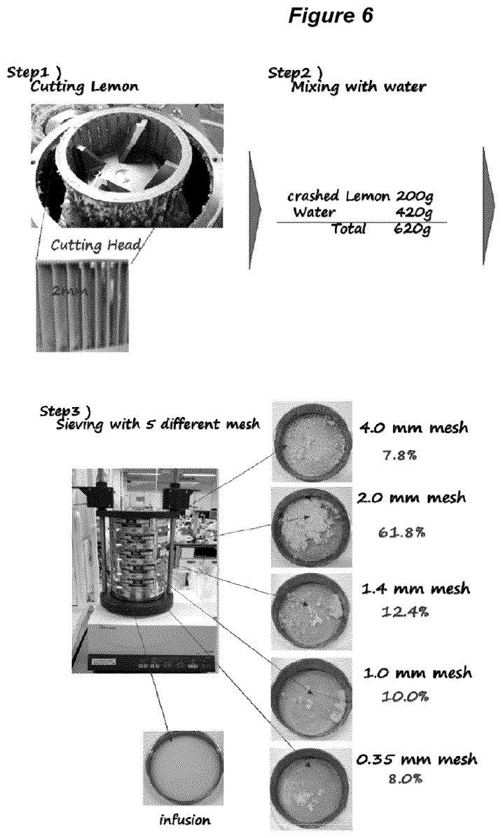

As shown in FIG. 6. Cutting lemon by using Micro mister, MASCO SANGYOCO LTD, with 2 mm Cutting Head. After that mixing 200 g of crushed lemon and 420 g of water.

To confirm crushed size, using Horizontal Sieve Shaker AS 400 control, RETSECH GmbH, with 5 different mesh 4.0 mm, 2.0 mm, 1.4 mm, 1.0 mm and 0.35 mm in 20 minutes. Results are shown in Table (7).

TABLE 7

| | |
|---|---|
| 4.0 mm mesh | 7.8% |
| 2.0 mm mesh | 61.8% |
| 1.4 mm mesh | 12.4% |
| 1.0 mm mesh | 10.0% |
| 0.35 mm mesh | 8.0% |

### Example 8—Physico-Chemical Analysis of Lemon Infusion

A whole fruit lemon infusion prepared according to the present invention (LIN2) was analysed and compared to alternative citrus preparations PEEL EXTRACT A (prepared using selected parts of the peel) and PEEL EXTRACT B (prepared using different selected parts of the peel).

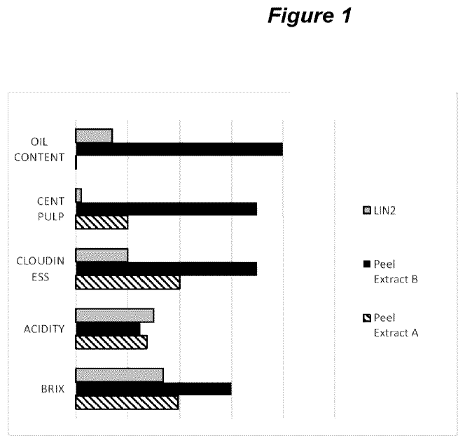

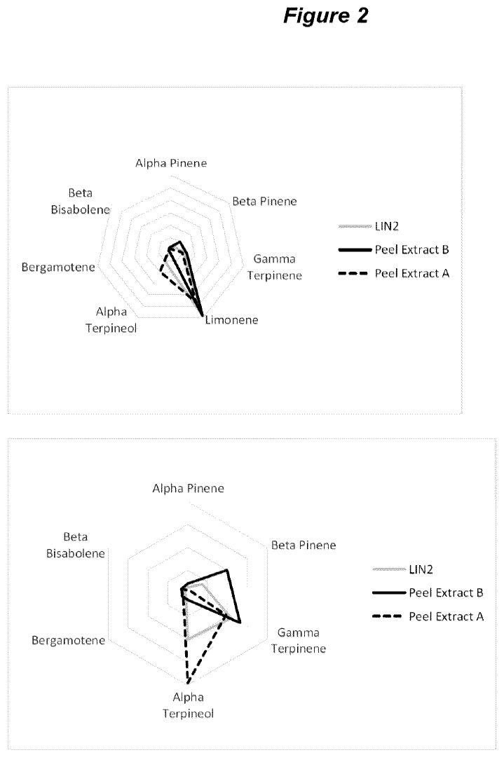

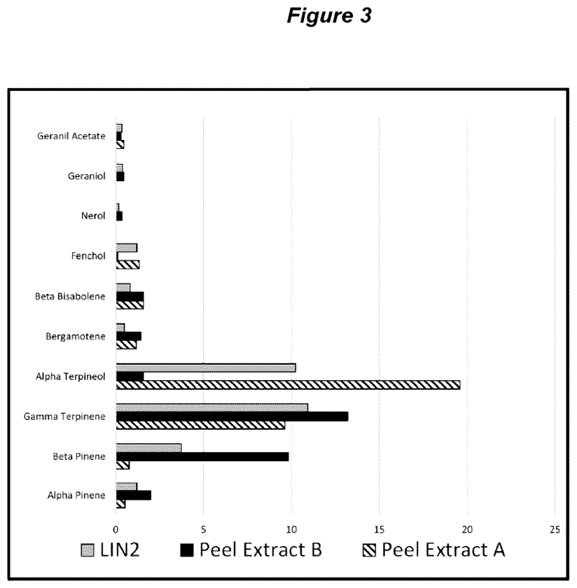

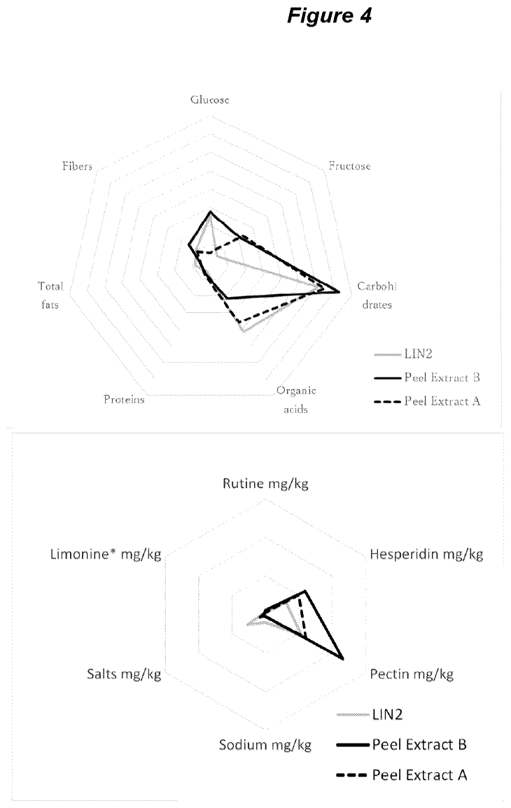

Results are shown in the tables below and are further illustrated in FIGS. 1 to 4.

TABLE 8a
ANALYSIS

| | | PEEL | PEEL | | |
|---|---|---|---|---|---|
| SAMPLE | | EXTRACT A | EXTRACT B | LIN2 | UNITS & METHOD |
| | RATIO F:W | 1:2 | 1:1 | 1:2.3 | |
| | (concentration) | | | | |
| DIRECT | BRIX | 3.08 | 4.69 | 2.63 | °Bx (Refractometer) |
| SAMPLE | ACIDITY | 0.732 | 0.656 | 0.793 | % ACA (Titrator) |
| | VISCOSITY | 4.2 | 5.7 | 20.61 | cSt (20° C.) (Capilar |
| | | | | | viscosimeter) |
| | TRANSMITTANCE | 58.2 | 10.5 | 68.5 | % T@425 nm (2%) |
| | | | | | (Spectrophotometer) |
| | CENT PULP | 2 | 9.6 | <0.4 | % (V/V) (Centrifuge) |
| | OIL CONTENT | 0.0067 | 0.357 | 0.0574 | % of d-limonen (Distillation) |
| | GC-PROFILE | | | | GC-CTC |

TABLE 8b
GC/MS Results

| | | | Area % comparison | | |
|---|---|---|---|---|---|
| | time | | PEEL | | PEEL |
| | (minute) | Component | EXTRACT B | LIN2 | EXTRACT A |
| more | 9.6 | Alpha Pinene | 2 | 1.21 | 0.54 |
| significant | 11 | Beta Pinene | 9.85 | 3.74 | 0.76 |
| peaks | 13.7 | Gamma Terpinene | 13.21 | 10.96 | 9.63 |
| | 17.6 | Alpha Terpineol | 1.57 | 10.24 | 19.6 |
| | 24.3 | Bergamotene | 1.45 | 0.52 | 1.19 |
| | 26 | Beta Bisabolene | 1.59 | 0.83 | 1.6 |
| less | 15.3 | Fenchol | 0.14 | 1.21 | 1.36 |
| significant | 18.6 | Nerol | 0.36 | 0.2 | 0 |
| peaks (but | 19.4 | Geraniol | 0.48 | 0.39 | 0 |
| differential) | 22.9 | Geranil Acetate | 0.3 | 0.36 | 0.49 |
| major | 12 > 8 | Limonene | 58.8 | 58.7 | 47.1 |
| component | | | | | |

TABLE 8c
nutritional analysis

| | PEEL | PEEL | | ANALYTICAL |
|---|---|---|---|---|
| | EXTRACT A | EXTRACT B | LIN2 | METHOD |
| Carbohydrates | 1.42 | 2.41 | 1.22 | HPLC/RI |
| Glucose | <0.5 | 0.9 | 0.5 | HPLC/RI |
| Fructose | 0.5 | 0.7 | <0.5 | HPLC/RI |
| Proteins | 0.16 | 0.22 | 0.1 | PNTA0135 |
| Fibre | 0.2 | 0.5 | 0.2 | PNTA0066 |
| | | | | (Gravimetric) |
| Pectin | 668 | 1914 | 539 | IFFJP No26 |
| Organic acids | 0.7966 | 0.7226 | 0.836 | (HPLC/UV) |
| Total fats | 0.11 | 0.17 | 0.17 | PNTA0172 |
| | | | | (Gravimetric) |
| Total energy | 10 | 15 | 9 | PNTA0193 |
| Salts mg/kg | 90 | 110 | 270 | Calculated |
| | | | | (NAx2.5) |
| Sodium mg/kg | 36 | 44 | 108 | PNTA0193 (ICP-MS) |
| Hesperidin | 550 | 984 | 307 | IFU N. 58 2005 |
| Limonine* | 16.8 | 19.8 | 26.6 | HPLC |
| Rutine mg/kg | 20.1 | 50.1 | 18.5 | MP0679 (HPLC) |

### Example 9: NTU Experimental Data

An experimental method was designed to measure the impact of citrus infusion addition on turbidity of the final drink. Four samples of final drink were prepared following the recipe of Example 2 and using two different citrus infusions (prepared with different citrus fruits) and also changing the amount of these infusions. Turbidity of the four samples was analysed using turbidimeter.

Results are shown in Table 9.

TABLE 9
Turbidity analysis:

| | | |
|---|---|---|
| | % of intense | TURBIDITY |
| PRODUCT | citrus INFUSION | (NTU) |

| | | | |
|---|---|---|---|
| FINAL DRINK containing | + | (0.87%) | 5.54 |
| lemon infusion | ++ | (1.5%) | 22 |
| FINAL DRINK containing | + | (1.05%) | 25.75 |
| orange infusion | ++ | (1.5%) | 33.4 |

+: initial amount of intense citrus infusion
++: increased amount of intense citrus infusion

### Example 10: From Concentrate Citrus Infusion Beverages

The physical properties of citrus infusion beverage concentrates and dilutions thereof were compared. The flavour of the diluted concentrates and the directly produced citrus infusion beverages were compared, to investigate the effect of the additional process step on the product.

The citrus beverage concentrate components are shown in Table 10a and are compared to the directly produced citrus infusion beverage, as in Example 2. Table 10b shows the Brix value, pH and turbidity (NTU) of the concentrated formulation shown in Table 10a, and a dilution of the concentrate—9.09 g made up to 200 ml with water.

TABLE 10a
Proportion of components in the directly produced citrus
infusion beverage and the concentrated formulation (%)

Proportion of components/%

| | Directly produced | Concentrated |
|---|---|---|
| Component | beverage | formulation |
| Water | 95.5 | 0 |
| Intense infusion | 1.5* | 33 |
| Juice | 2 | 44 |
| Flavour | 1 | 22 |
| Preservatives (sorbate) | 0 | 1 |

*1.5% intense infusion, corresponding to 25% standard strength infusion, according to THIE calculation.

TABLE 10b
Brix value, pH and turbidity (NTU) of the concentrated
formulation and a dilution of the concentration
- 9.09 g made up to 200 ml with water

| Analysis | Concentrated formulation | Concentrate dilution |
|---|---|---|
| BRIX | 38.13 | 1.70 |
| PH | 2.09 | 2.46 |
| NTU | 1943 | 68.2 |

A taste comparison of the concentrate dilution of Table 10b and the directly produced beverages was performed in order to identify sensory profile differences related to common sensory attributes for soft drinks including, for example, basic taste attributes: acidity, bitterness, sweetness, overall intensity, as well as more concrete ones, for example: freshness, citrus notes and aftertaste. The taste comparison was done by 3 scientific technicians in a comparison test, having one sample of each product and looking for differences and similarities between them. The comparison showed no significant differences between the flavours of each beverage. The diluted concentrate retained a fresh taste and was in line with the final drink targets. The high dilution ratio resulted in complete sorbate dissolution.

### Example 11: Evaluation of Various Citrus Beverages at Different Concentrations

In order to evaluate the effects of concentration of the infusion on the properties of citrus beverages, sample beverages containing water (treated water) and a lemon intense infusion at different concentrations (Run 1 to 5) were prepared and tested. A lemon intense infusion and water were mixed so as to have the compounding amount shown in Table 11 and then filled in a PET bottle container to prepare a sample solution. The infusion used to prepare the samples was produced according to the present invention (LIN2). The treated water is from Citricos y Refrescantes Manufacturing plant in Tordera that goes through an osmotic treatment before its usage (pH=6.5).

PH of the five samples was measured using a pH-meter. Turbidity of the five samples was analysed using turbidimeter. Brix value was measured using a refractometer. Brix of the lemon intense infusion (LIN2) was 3.05.

For tasting, a panel of 3 trained people was selected and tasted the samples in order to quantify and qualify the different attributes defined, to understand organoleptic profile of the sample beverages. The objective of the tasting was to identify the intensity of the different attributes agreed and place it in the scale from 0 to 5 (0 being not present and 5 being the highest level). Results are shown in Table 11.

TABLE 11
Turbidity (NTU), pH and taste of various
citrus beverages with Treated Water

| | Run 1 | Run 2 | Run 3 | Run 4 | Run 5 |
|---|---|---|---|---|---|
| Concentration | 0 | 2.5 | 5.0 | 7.5 | 10 |
| (g/l) | | | | | |
| Turbidity | 0.079 | 7.14 | 15.6 | 25.0 | 34.7 |
| (NTU) | | | | | |
| pH | 6.52 | 6.14 | 5.50 | 4.96 | 4.64 |
| Taste (1-5) | | | | | |
| Refreshing | 0 | 1.5 | 2.0 | 3.0 | 3.5 |
| Lemon | 0 | 0.25 | 1.25 | 2.25 | 4.0 |
| intensity | | | | | |
| Acidity | 0 | 0.75 | 1.0 | 1.25 | 1.5 |
| balance | | | | | |
| Astringency | 0.25 | 0.5 | 0.75 | 1.0 | 2.0 |

1. A container-packed beverage comprising an infusion of a citrus fruit, wherein the beverage has
a turbidity of 75 NTU or less;
a pH of 2 to 7.

2. A beverage comprising an infusion of a citrus fruit, wherein the beverage has
a turbidity of 75 NTU or less;
a pH of 2 to 7; and
a soluble solids content of at least 0.1 Brix.

3. A beverage according to claim 2, wherein the beverage is a container-packed beverage.

4. A beverage according to claim 1, wherein the container is selected from a can, a glass bottle, a plastic bottle and a barrel.

5. A beverage according to claim 1, wherein the container has a volume of 2 litres or less, preferably 1 litre or less, more preferably 500 ml or less.

6. A beverage according to claim 1, wherein the beverage has a pH of 3.0 to 5.0, preferably 3.5 to 4.5.

7. A beverage according to claim 1, wherein the infusion is a whole fruit infusion of the citrus fruit.

8. A beverage according to claim 7, wherein the infusion is obtained by immersing a ground whole citrus fruit.

9. A beverage according to claim 1, further comprising a juice of a citrus fruit.

10. A beverage according to claim 7, wherein the beverage contains the juice in an amount of 2.0 g/L or less based on the total volume of the beverage.

11. A beverage according to claim 1, wherein the beverage contains the infusion in an amount equivalent to 15 to 30% (w/w) of a standard strength fruit infusion, preferably in an amount equivalent to about 25% (w/w) of a standard strength fruit infusion.

12. A beverage according to claim 1, wherein the beverage contains the infusion in an amount providing from 0.2 g/L to 0.4 g/L dry matter in the final beverage.

13. A beverage according to claim 1, wherein the beverage contains no additional sweetener, or the beverage contains an additional sweetener in an amount providing a sweetness in the beverage equivalent to 5.0 degrees Brix of sucrose or less, preferably 3.0 degrees Brix of sucrose or less.

14. A beverage according to claim 1, wherein the citrus fruit comprises one or more fruit selected from the group consisting of lemon, orange, mandarin, grapefruit, lime or other citrus fruits.

15. A beverage according to claim 1, wherein the beverage is pasteurised.

16. A concentrate for preparation of a beverage according to claim 1.

17. A concentrate according to claim 16, which is a 2 to 35-fold concentrate, preferably a 3 to 30-fold concentrate, more preferably a 5 to 25-fold concentrate, of said beverage.

18. A concentrate according to claim 16, wherein said concentrate comprises an infusion of a citrus fruit, preferably a whole fruit infusion, preferably in an amount contributing from 5 to 20 g/L dry matter to the concentrate.

19. A concentrate according to claim 16, wherein said concentrate has a turbidity of less than 2500 NTU and a pH between 1 and 4.

20. A method for preparing an infusion of a citrus fruit, comprising:
grinding a whole fruit of the citrus fruit into a size of 0.5 mm to 30 mm to obtain a ground citrus fruit; and
immersing the ground citrus fruit in water at a water temperature of 55° C. or less to obtain an infusion.

21. A method according to claim 20, wherein the grinding of the whole fruit of the citrus fruit is conducted with equipment comprising a plurality of openings each having a diameter of 0.5 mm to 30 mm, wherein said equipment is preferably a mesh.

22. A method according to claim 20, further comprising;
optionally, adding further beverage ingredients;
diluting said infusion with water;
to produce a beverage.

23. A product obtainable by a method according to claim 20.

24. A product according to claim 23 which is a beverage, an ingredient for use in a beverage, or a concentrate for preparation of a beverage.

25. A product according to claim 24 which is the beverage.
